(19) United States
(12) Patent Application Publication
(10) Pub. No.: US 2015/0154510 A1
(43) Pub. Date: Jun. 4, 2015

(54) ELECTRONIC DEVICE

(71) Applicant: Kabushiki Kaisha Toshiba, Tokyo (JP)

(72) Inventor: Tatsuo Yamaguchi, Kunitachi Tokyo (JP)

(21) Appl. No.: 14/618,636

(22) Filed: Feb. 10, 2015

Related U.S. Application Data
(63) Continuation of application No. PCT/JP2013/058617, filed on Mar. 25, 2013.

(51) Int. Cl. G06Q 10/00

(52) U.S. Cl. CPC G06Q 10/00; G06Q 2220/10

(57) ABSTRACT

According to one embodiment, an electronic device capable of logging in by switching accounts, includes a processor. The processor determines whether the device can communicate with a predetermined external electronic apparatus, and controls switching the accounts based on a result of the determination.

### CROSS REFERENCE TO RELATED APPLICATIONS

This application is a Continuation Application of PCT Application No. PCT/JP2013/058617, filed Mar. 25, 2013, the entire contents of which are incorporated herein by reference.

### FIELD

Embodiments described herein relate generally to an electronic device which controls switching of a user account.

### BACKGROUND

In recent years, companies draw attention to bringing an individually-owned information device or the like to the office and using it in business (so-called Bring Your Own Device [BYOD]). For information devices, various electronic devices such as tablet devices and smartphones can be used.

To realize BYOD, it is necessary to implement various security measures for electronic devices.

It is not desirable that a private user account be used inside a company. Nor is it desirable that a business user account be used outside a company. There is a demand for controlling switching of a user account in accordance with the location of use of an electronic device.

Embodiments described herein aim to provide an electronic device capable of controlling switching of a user in accordance with the location of use.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a configuration of an electronic device of an embodiment.

FIG. 2 is a flowchart illustrating processing of controlling switching of an account.

FIG. 3 is a flowchart illustrating processing of controlling login to a user account.

### DETAILED DESCRIPTION

Various embodiments will be described hereinafter with reference to the accompanying drawings.

In general, according to one embodiment, an electronic device capable of logging in by switching accounts, includes a processor. The processor determines whether the device can communicate with a predetermined external electronic apparatus, and controls switching the accounts based on a result of the determination.

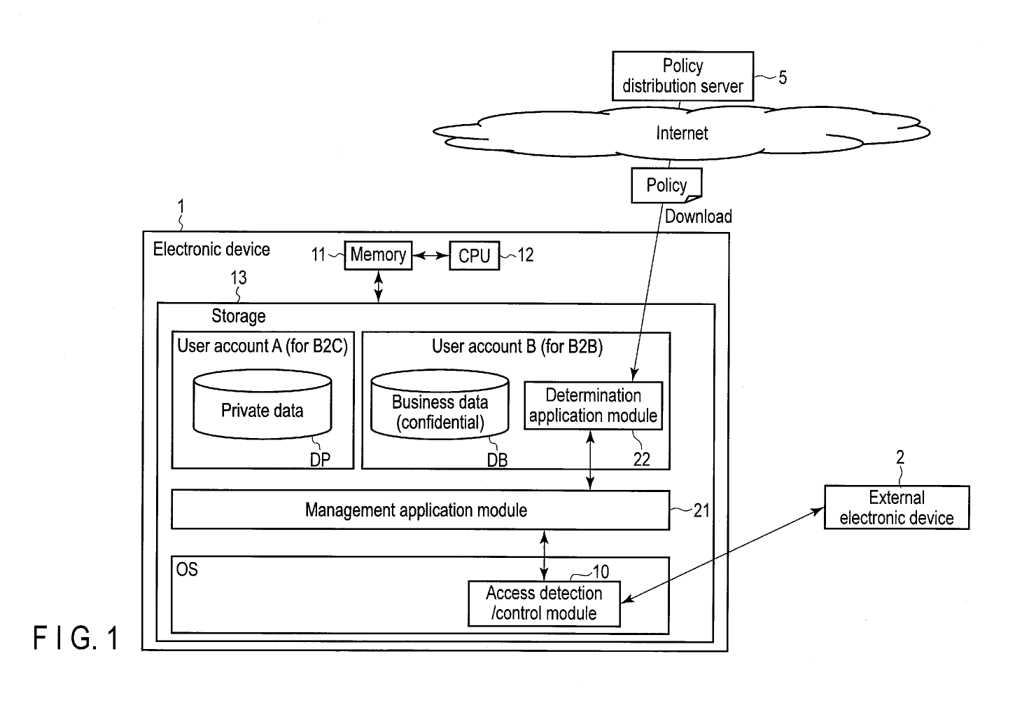

FIG. 1 illustrates the configuration of an electronic device 1 of an embodiment. The electronic device 1 is configured to execute various application programs, which are realized by, for example, a tablet device, a smartphone, a PDA, or other information devices. The electronic device 1 is configured to execute wireless communication that each corresponds to several wireless communication standards such as WiFi (registered trademark), third-generation mobile Telecommunication (3G), and Bluetooth (registered trademark). The electronic device 1 can communicate with an external electronic device 2 (external electronic device), which includes a wireless access point, a Bluetooth device, a USB dongle, etc., and various servers on the Internet. Also, the electronic device 1 has a function to access to an external device such as a USB memory and a SD memory card.

User account A and user account B are set in the electronic device 1. The user can log in to either user account A or user account B and can use the environment of a logged-in user account. User account A is a private user account (business-to-consumer [B2C]); user account B is a business user account (business-to-business [B2B]).

When login is made to user account A, the user can refer to private data DP. When login is made to user account B, the user can refer to business data DB, which is confidential.

The electronic device 1 has a function to control various processing such as a function to control switching for performing switching of a user account, etc. In order to realize the function to control switching, the electronic device 1 includes three different modules, i.e., an access detection/control module 10, a management application module 21, and a determination application module 22.

The electronic device 1 comprises Central Processing Processor (CPU) 11, a memory 12, and storage 13. The access detection/control module 10, the management application module 21, and the determination application module 22 are stored in the storage 13. The access detection/control module 10, the management application module 21, and the determination application module 22 are loaded into the memory 12. The CPU 11 is executable the access detection/control module 10, the management application module 21, and the determination application module 22 which are load to the memory 12.

The access detection/control module 10 can be realized by a software module in an operating system (OS) layer. The software module may be, for example, a middleware in an OS layer or a kernel in an OS layer such as a Linux (registered trademark) kernel. The management application module 21 and the determination application module 22 can each be realized by an application program executed on an application execution module 20. The application program may be, for example, an Android (registered trademark) application program.

The management application module 21 and the determination application module 22 are assigned a system privilege and cannot stop processing.

The access detection/control module 10 has a function to detect a predetermined external electronic device of the electronic device 1. The access detection/control module 10 acquires, from an external electronic device, identification information unique to the device.

The access detection/control module 10 acquires an identifier from a WiFi access point. The identifier is, for example, a service set identifier (SSID), an extended service set identifier (ESSID), a basic service set identifier (BSSID), etc. Also, the access detection/control module 10 acquires a serial number from, for example, a mutually-identified predetermined Bluetooth device. That is, the Bluetooth device is used as a token. Further, the access detection/control module 10 acquires a USB dongle, for example.

The access detection/control module 10 transmits event information including identification information to the management application module 21. Upon receiving event information from the access detection/control unit 10, the management application module 21 notifies the contents of the received event information to the determination application module 22. The determination application module 22 determines whether the electronic device 1 is being used inside or outside a company based on identification information. Action information in accordance with the processing is notified to the access detection/control module 10 from the determination application module 22 via the management application module 21. The access detection/control module 10 performs processing of switching an account in accordance with action information.

Also, the access detection/control module 10 detects a login request to a user account. When there is a login request to a user account, the access detection/control module 10 transmits, to the management application module 21, event information that indicates a requested user account. The event information is transferred from the management application module 21 to the determination application module 22.

The determination application module 22 determines processing in accordance with event information. Action information in accordance with the processing is notified to the access detection/control module 10 from the determination application module 22 via the management application module 21. The access detection/control module 10 performs processing of controlling switching of a user account in accordance with action information.

The determination application module 22 has a predetermined policy (determination rule), based on which the determination application module 22 notifies, to the management application module 21, processing corresponding to each event received from the management application module 21. The determination application module 22 can, if necessary, download a policy (determination rule) from a policy distribution server 5. By downloading a policy (determination rule) from the policy distribution server 5, the policy can be easily updated on a regular basis, for example. Also, a policy may be incorporated into the determination application module 22 in advance.

The processing of switching an account corresponding to a case where the electronic device 1 is being used inside a company is to enable logging in to business user account B but disable logging in to private user account A. Also, the processing of switching an account is to make user account A initially logged out during login to user account A. The operation of private user account A, which is not under control of company, is disabled by performing the above-mentioned account switching processing in a case where the electronic device 1 is being used inside a company. From a viewpoint of employee, there is no concern that the private data of an individual employee is set under control of company.

The processing of switching an account corresponding to a case where the electronic device 1 is being used outside a company is to enable logging in to private user account A but disable logging in to business user account B. Also, the processing is to make user account B initially logged out during login to user account B. By performing the above-mentioned processing, the operation of business user account B, which includes confidential data of a company, is disabled outside a company in a case where the electronic device 1 is being used outside a company.

Also, connection to an access point is controlled based on a policy.

The access detection/control module 10 detects an access point, from which the access detection/control module 10 acquires an identifier such as SSID, ESSID or BSSID.

The access detection/control module 10 notifies an identifier to the management application module 21. The management application module 21 notifies an identifier to the determination application module 22. The determination application module 22 determines whether connection can be made to an access point based on an identifier and a policy.

The determination application module 22 notifies the result of determination to the management application module 21. The management application module 21 notifies the result of determination to the access detection/control module 10. The access detection/control module 10 controls connection in accordance with the result of determination.

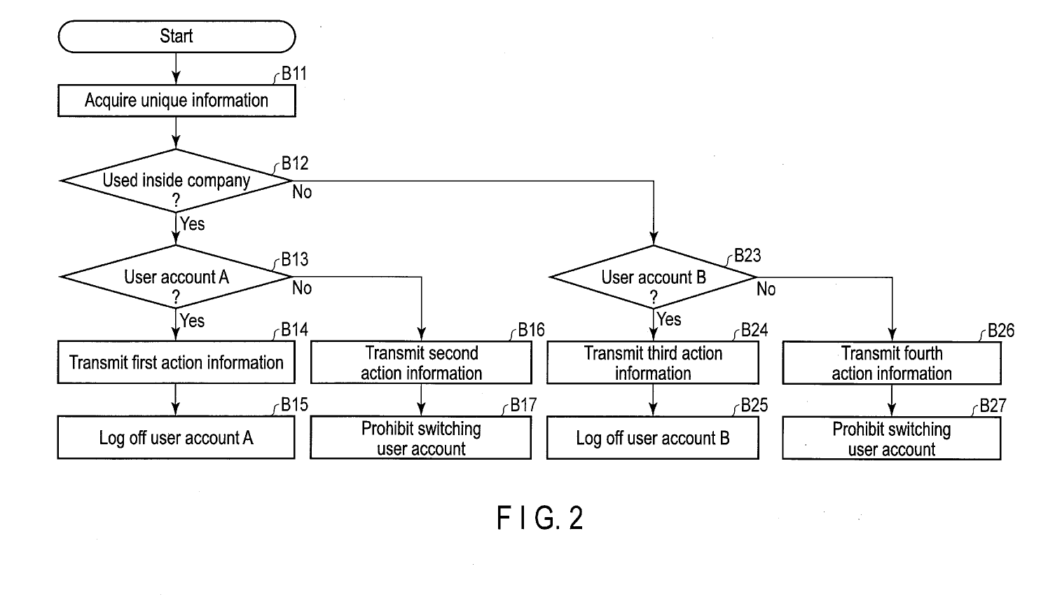

Next, a description will be given of the steps of processing in a case where the access detection/control module 10 determines whether communication can be performed with a predetermined external electronic device with reference to FIG. 2.

The access detection/control module 10 detects an external electronic device. The access detection/control module 10 acquires identification information from a detected external electronic device (block B11). The access detection/control module 10 notifies event information including identification information to the management application module 21. The management application module 21 notifies event information to the determination application module 22.

The determination application module 22 determines whether the electronic device 1 is being used inside a company based on identification information and a policy included in event information (block B12). If identification information is registered in a policy, the determination application module 22 determines that the electronic device 1 is being used inside a company. If no identification information is registered in a policy, the determination application module 22 determines that the electronic device 1 is not being used inside a company (i.e., being used outside a company).

If it is determined that the electronic device 1 is being used inside a company (block B12, Yes), the determination application module 22 determines whether a currently-used account is private user account A (block B13). If it is determined that the currently-used account is private user account A (block B13, Yes), the determination application module 22 transmits to the management application module 21 first action information for logging out from user account A (block B14). The management application module 21 transmits the first action information to the access detection/control module 10. The access detection/control module 10 logs out from user account A (block B15).

If it is determined that the currently-used account is not user account A (block B13, No), the determination application module 22 transmits to the management application module 21 second action information for prohibiting switching to user account A (block B16). The management application module 21 transmits the second information to the access detection/control module 10. The access detection/control module 10 controls to prohibit switching to user account A (block B17).

If it is determined in block B12 that the electronic device 1 is not being used inside a company (block B12, No), the determination application 22 determines whether a currently-used account is business user account B (block B23). If it is determined that the currently-used account is business user account B (block B23, Yes), the determination application module 22 transmits to the management application module 21 third action information for logging out from user account B (block B24). The management application module 21 transmits the third action information to the access detection/control module 10. The access detection/control module 10 logs out from user account B (block B25).

If it is determined that the currently-used account is not user account B (block B23, No), the determination application module 22 transmits to the management application module 21 fourth action information for prohibiting switching to user account B (block B26). The management application module 21 transmits the fourth information to the access detection/control module 10. The access detection/control module 10 controls to prohibit switching to user account B (block B27). The control to prohibit switching to user account B may be performed by the management application module 21.

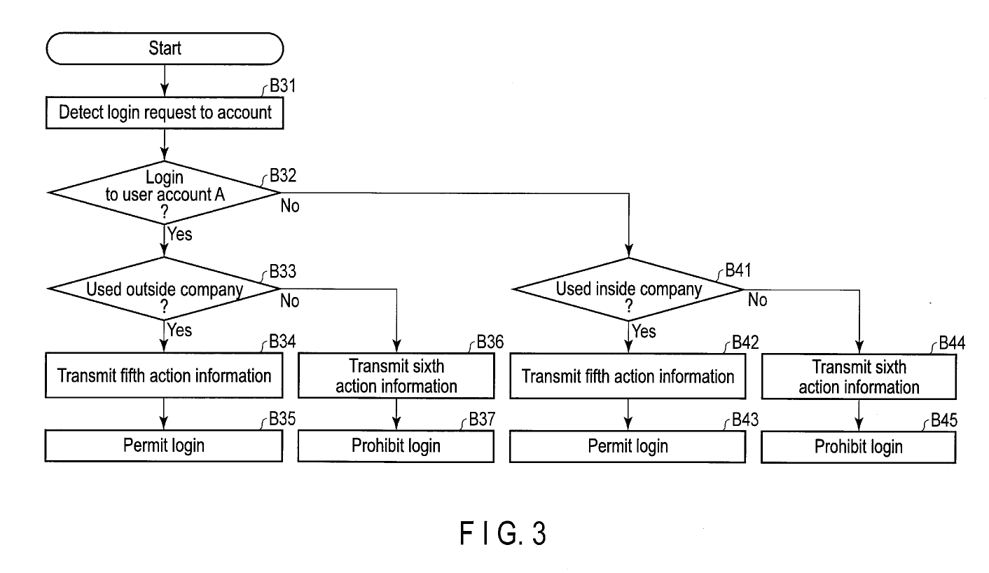

Next, a description will be given of the steps of processing in a case where the access detection/control module 10 detects a login request to an account with reference to FIG. 3.

The access detection/control module 10 detects a login request to an account (block B31). The access detection/control module 10 notifies, to the management application module 21, event information that indicates that there has been a login request to the account. Event information includes information that indicates a user account where there has been a login request. The management application module 21 notifies event information to the determination application module 22. The determination application module 22 determines whether a login request is made to user account A based on the event information (block B32). If it is determined that a login request is made to user account A (block B32, Yes), the determination application module 22 determines whether the electronic device 1 is being used outside a company (block B33). If it is determined that the electronic device 1 is being used outside a company (block B33, Yes), the determination application module 22 transmits to the management application module 21 fifth action information for permitting login (block B34). The management application module 21 transmits the fifth action information to the access detection/control module 10. The access detection/control module 10 permits login to user account A (block B35).

If it is determined that the electronic device 1 is not being used outside a company (block B33, No), the determination application module 22 transmits to the management application module 21 sixth action information for prohibiting login (block B36). The management application module 21 transmits the sixth action information to the access detection/control module 10. The access detection/control module 10 prohibits login to user account A (block B37).

If it is determined in block B32 that the login is made not to user account A (block B32, No), the determination application module 22 determines whether the electronic device 1 is being used inside a company (block B41). If it is determined that the electronic device 1 is being used inside a company (block B41, Yes), the determination application module 22 transmits to the management application module 21 the fifth action information for permitting login (block B42). The management application module 21 transmits the fifth action information to the access detection/control module 10. The access detection/control module 10 permits login to user account B (block B43).

If it is determined that the electronic device 1 is not being used inside a company (block B41, No), the determination application module 22 transmits to the management application module 21 the sixth action information for prohibiting login (block B44). The management application module 21 transmits the sixth action information to the access detection/control module 10. The access detection/control module 10 prohibits login to user account B (block B45).

The determination application module 22 stores a location where the electronic device 1 is being used. The determination application module 22 stores an account that is currently logged in.

It is determined whether the electronic device 1 is being used inside a company by determining whether the electronic device can communicate with a predetermined external electronic device. It is therefore possible to control switching of a user account in accordance with the location where the electronic device 1 is being used.

All the steps of processing performed in the embodiment can be realized by software. Therefore, the same advantage as that of the embodiment can be obtained by installing a computer program that executes these steps in a normal computer through a computer-readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device capable of logging in by switching accounts, the device comprising:
a processor to determine whether the device can communicate with a predetermined external electronic apparatus, and to control switching the accounts based on a result of the determination.

2. The device of claim 1, wherein
the accounts include a first account and a second account,
the processor prohibits switching from the first account to the second account when it is determined that the device can communicate with the apparatus and is logged in by the first account,
the processor logs out of the second account when it is determined that the device can communicate with the apparatus and is logged in by the second account,
the processor prohibits switching from the second account to the first account when it is determined that the device cannot communicate with the apparatus and is logged in by the second account, and
the processor logs out of the first account when it is determined that the device cannot communicate with the apparatus and is logged in by the first account.

3. The device of claim 1, wherein the processor detects a login request to one of the accounts,
the processor permits or prohibits login to the one of the accounts in accordance with a result of detection and a result of the determination.

4. The device of claim 3, wherein
the accounts comprises a first account and a second account,
the determination permits a login request to the first account when it is determined that the device can communicate with the apparatus and a login request to the first account is detected,
the processor prohibits a login request to the second account when the it is determined that the device can communicate with the apparatus and a login request to the second account is detected,
the processor prohibits a login request to the first account when the it is determined that the device cannot communicate with the apparatus and a login request to the first account is detected, and
the processor permits a login request to the second account when the it is determined that the device cannot communicate with the apparatus and a login request to the second account is detected.

5. The device of claim 1, wherein
the apparatus comprises at least one of an access point having a predetermined identifier, a mutually-identified predetermined near-field wireless communication device, and a predetermined token.

6. A control method of an electronic device capable of logging in by switching accounts, the method comprising:
determining whether the device can communicate with a predetermined external electronic apparatus; and
controlling switching the accounts based on a result of the determination.

7. A computer-readable, non-transitory storage medium having stored thereon a computer program which is executable by a computer capable of logging in by switching a plurality of accounts, the computer program controlling the computer to execute functions of:
determining whether the electronic device can communicate with a predetermined external electronic device; and
controlling switching the plurality of accounts based on a result of the determination.
